(19) United States
(12) Patent Application Publication
(10) Pub. No.: US 2024/0338798 A1
(43) Pub. Date: Oct. 10, 2024

(54) IMAGE PROCESSING MODULE

(71) Applicant: LG INNOTEK CO., LTD., Seoul (KR)

(72) Inventor: Jung Ah PARK, Seoul (KR)

(21) Appl. No.: 18/294,057

(22) PCT Filed: Aug. 4, 2022
(86) PCT No.: PCT/KR2022/011565

§ 371 Date: Jan. 31, 2024

(30) Foreign Application Priority Data
Aug. 5, 2021 (KR) 10-2021-0103284
Aug. 12, 2021 (KR) 10-2021-0106985
Aug. 12, 2021 (KR) 10-2021-0106986

(51) Int. Cl. G06T 5/60; G06T 5/50; G06T 5/70

(52) U.S. Cl. CPC G06T 5/60; G06T 5/50; G06T 5/70; G06T 2207/20081; G06T 2207/20084

(57) ABSTRACT

An image processing module according to an embodiment of the present invention comprises: an input unit for receiving a first image data generated using a light transmitted through a display panel; and a deep learning neural network for outputting a second image data from the first image data, wherein the second image data is an image data from which at least a portion of noise, which is a picture quality degradation phenomenon that occurs when the light is transmitted through the display panel, is removed.

### TECHNICAL FIELD

The present invention relates to an image processing module, and more particularly, relates to an image processing module that improves image quality degradation phenomenon in an image data being generated using a light transmitted through a display panel, a camera module, an image processing method, an image processing module that minimizes the impact of the image sensor and image pre-processing module on the image sensor module and AP module, and a camera device.

### BACKGROUND ART

For personal broadcasting using a smartphone, watching TV or watching various contents, for an immersive watching of a video with visual acuity and concentration, the camera is hidden inside the display and the entire front is designed with a full display. A camera being embedded inside the display is called an under display camera and is commonly referred to as UDC. The image quality is deteriorated due to the display panel, and attempts are undergoing to improve it. The degradation of camera image quality due to the display panel seems to raise a variety of issues.

Typically, the amount of light drops sharply, and when high gain is used to make it up, noise is generated, but to remove this, processing with SW or ISP in AP will blur the image. In addition, due to the pattern of the display panel, it may cause various problems such as blur, haze (diffraction ghost), reflection ghost, flare, and the like that are more severe than the existing conventional cameras.

Various technologies are being developed to improve the image quality level to that of a general camera. Although processing ISP at the final smartphone stage may improve the basic light intensity and yellowish phenomenon, it is not easy to improve other phenomena and difficult to process quickly, so there is a problem in that image processing is delayed in a camera mode where real time performance is essential such as video calls and personal broadcasting, and the like.

In addition, in photographing a realistic image using a smartphone camera and displaying the image, the resolution is gradually increasing as display technology advances, and naturally, the demand for super high resolution and image quality improvement is increasing. Industries that make sensors to meet these requirements bring various sensor technologies of DSLR to mobile devices to implement high resolution up to 48M, while attempts to implement super resolution with SW algorithm for vivid picture quality in TVs have been tried. In addition, a zoom function is being developed for a wider angle of view and photographing more distant objects in detail.

Although there is a method of optical zoom with hardware, the hardware structure is complicated and the price increase is inevitable due to the addition of these parts. In addition, there is a limit to the area that can be zoomed using optics, so development of processing this area with software is being made. In addition, various attempts are being made to create high resolution images using the same sensor.

There are technologies creating higher resolution by moving hardware parts to generate more pixel information such as a sensor shift technology that shakes the sensor using VCM or MEMS technology, an OIS technology that obtains pixel information by shaking the lens with VCM, a technology that shakes the filter between the sensor and the lens, and the like.

A disadvantage of this technique is that since data of several parallaxes are synthesized, artifacts such as motion blur occur when a moving object is photographed, which is a fatal problem that degrades image quality. In addition, the size of the camera module increases by adopting a complex hardware structure for implementing this, and since it is a method of shaking parts, so there is a limit in that it is a limited technology that can be used in a stationary environment as it is difficult to use in a vehicle camera.

In addition, with the development of artificial intelligence technology, research to use artificial intelligence technology for image processing is being conducted, but it is not yet optimized for a specific product such as a camera, and because it is a very expensive AP, it can be applied only to premium models among smartphones.

In order to apply to models other than the premium class, since it is necessary to use a low-cost AP, and the resulting S/W processing should be simplified, it is difficult for AP to receive this high-spec camera data and process it in various ways no matter how good the camera is. If a chip with pre-processing function is added separately from the camera sensor, dependence on sensor can be reduced, but since the MIPI interface is embedded twice, there is a problem in that the price and size is increasing in terms of overall sensors and chips.

### DETAILED DESCRIPTION OF THE INVENTION

### Technical Subject

The technical problem to be solved by the present invention is to provide an image processing module, a camera module, and an image processing method for improving image quality degradation phenomenon in an image data being generated using a light transmitted through a display panel.

Another technical problem to be solved by the present invention is to provide an image sensor and an image processing method for improving image quality degradation phenomenon in an image data being generated using a light transmitted through a display panel.

Yet another technical problem to be solved by the present invention is to provide an image processing module and a camera device that minimizes the effect of the image preprocessing module on the image sensor module and the AP module.

### Technical Solution

In order to solve the above technical problem, an image processing module according to an embodiment of the present invention is characterized by comprising: an input unit for receiving first image data being generated using a light transmitted through a display panel; and a deep learning neural network for outputting second image data from the first image data, wherein the second image data is an image data from which at least a portion of noise, which is a picture quality degradation phenomenon that occurs when the light transmits through the display panel, is removed.

In addition, the noise may include at least one among low intensity, blur, haze (diffraction ghost), reflection ghost, color separation, flare, fringe pattern, and yellowish phenomenon.

In addition, the input unit may receive the first image data from an image sensor disposed under a display panel.

In addition, the first image data and the second image data may have different noise levels.

In addition, the training set of the deep learning neural network may include a first image data being generated using a light transmitted through a display panel and a second image data being generated using a light not transmitted through a display panel.

In addition, at least one of the first image data and the second image data may be a Bayer image data.

In addition, the second image data may be outputted to an image signal processor.

In order to solve the above technical problem, an image processing module according to another embodiment of the present invention is characterized by comprising: at least one processor; and a memory for storing instructions processed by the processor, wherein the processor receives a first image data being generated using a light transmitted through a display panel according to an instruction stored in the memory and outputs a second image data from the first image data, and wherein the second image data is an image data from which at least a portion of noise, which is an image quality degradation phenomenon that occurs when the light transmits through the display panel, is removed.

In order to solve the above technical problem, a camera module according to an embodiment of the present invention is characterized by comprising: an image sensor for generating a first image data using a light transmitted through a display panel; a driver IC for controlling the image sensor; and an image processing module according to the embodiment of the present invention, and being disposed under the display panel.

In addition, the image processing module may be formed as one chip with the driver IC.

In addition, the image processing module may be formed as a chip separate from the driver IC.

In order to solve the above technical problem, an image processing method according to an embodiment of the present invention is characterized by comprising the steps of: receiving a first image data being generated using a light transmitted through a display panel; and outputting a second image data from the first image data using a deep learning neural network being learned, wherein the second image data is an image data from which at least a portion of noise, which is an image quality degradation phenomenon that occurs when the light is transmitted through a display panel, is removed.

In addition, the training set of the deep learning neural network may include a first image data being generated using a light transmitted through a display panel and a second image data being generated using a light not transmitted through a display panel.

In addition, the first image data may be inputted from an image sensor being disposed under the display panel, and the second image data may be outputted to an image signal processor.

In order to solve the other technical problem, an image sensor according to an embodiment of the present invention comprises: an image sensing unit for generating a first image data using a light transmitted through a display panel; a deep learning neural network for outputting a second image data from the first image data; and an output unit for outputting the second image data to the outside, wherein the deep learning neural network outputs second image data according to an output format of the output unit.

In addition, an alignment unit for outputting a third image data by decomposing or rearranging at least a portion of the first image data is included, wherein the deep learning neural network may output the second image data from the third image data.

In addition, the alignment unit may output the third image data according to an output format of the output unit.

In addition, the second image data may be image data from which at least a portion of noise, which is an image quality degradation phenomenon that occurs when the light transmits through the display panel, is removed.

In addition, the noise may include at least one among a low intensity, a blur, a haze (diffraction ghost), a reflection ghost, color separation, a flare, a fringe pattern, and a yellowish phenomenon.

In addition, the image sensing unit may be disposed under a display panel.

In addition, the training set of the deep learning neural network may include a first image data being generated using a light transmitted through a display panel and a second image data being generated using a light not transmitted through a display panel.

In addition, at least one of the first image data and the second image data may be a Bayer image data.

In addition, the output unit may output the second image data to an image signal processor.

In order to solve the above technical problem, an image sensor according to another embodiment of the present invention is characterized by comprising: a pixel array for receiving a light transmitted through a display panel; a first processor and a second processor; and a memory for storing an instruction being processed by the first processor or the second processor, wherein the first processor generates a first image data using an output of the pixel array according to the instruction stored in the memory, wherein the second processor outputs a second image data from the first image data according to the instruction stored in the memory, and wherein the second image data is an image data being outputted in which at least portion of noise, which is a picture quality degradation phenomenon that occurs when the light transmits through a display panel, is removed, and being outputted according to an output format.

In order to solve the above technical problem, an image processing method according to an embodiment of the present invention is characterized by comprising the steps of: generating a first image data using a light transmitted through a display panel; and outputting a second image data from the first image data using a learned deep learning neural network, wherein the second image data is an image data in which at least a portion of noise, which is a picture quality degradation phenomenon that occurs when the light transmits through a display panel, is removed, and being outputted according to a communication format.

In addition, a step of outputting a third image data by decomposing or rearranging at least a portion of the first image data is included, wherein the step of outputting the second image data may output the second image data from the third image data.

In addition, the second image data may be outputted to an image signal processor.

In order to solve yet another technical problem, an image processing module according to an embodiment of the present invention comprises: a first connector being connected to an image sensor module and receiving a first image data; a deep learning neural network for outputting a second image data from the first image data being received through the first connector; and a second connector being connected to an application processor (AP) module and outputting the second image data.

In addition, a bridge may be formed between the image sensor module and the AP module. In addition, it may be disposed on the same substrate as at least one of the image sensor module and the AP module.

In addition, it may be disposed to be spaced apart from the image sensor module or the AP module.

In addition, the image sensor module may be disposed under a display panel.

In addition, the first image data is image data being generated using a light transmitted through a display panel, and the second image data may be an image data from which at least a portion of noise, which is an image quality degradation phenomenon that occurs when the light transmits through a display panel, is removed.

In addition, the noise may include at least one among a low intensity, a blur, a haze (diffraction ghost), a reflection ghost, a color separation, a flare, a fringe pattern, and a yellowish phenomenon.

In addition, a training set of the deep learning neural network may include a first image data being generated using a light transmitted through a display panel and a second image data being generated using a light not transmitted through a display panel.

In addition, the first image data is an image data having a first resolution, and the second image data may be an image data having a second resolution.

In addition, the first resolution may be higher than the second resolution.

In addition, the training set of the deep learning neural network may include a first image data having a first resolution and a second image data having a second resolution.

In addition, at least one of the first image data and the second image data may be a Bayer image data.

In order to solve the above technical problem, a camera device according to an embodiment of the present invention comprises: an image sensor module for generating a first image data; an image processing module including a deep learning neural network for receiving a first image data from the image sensor and outputting a second image data from the first image data; and an application processor (AP) module for receiving a second image data from the deep learning neural network and generating an image from the second image data, wherein the image processing module connects between the image sensor and the AP module by including a first connector being connected to the image sensor and a second connector being connected to the AP module, and is disposed with at least one of the image sensor and the AP module on the same substrate to be spaced apart from each other.

### Advantageous Effects

According to embodiments of the present invention, it is possible to improve image quality degradation in image data being generated using a light transmitted through a display panel. In addition, it can be processed with low power consumption while running in real time by using a HW accelerator. Low power consumption and fast processing are possible through pre-processing before ISP. Most of them are multiplexing HW, which is a deep learning based technology that is easy to optimize with a HW accelerator. In addition, by using only a few line buffers, and optimizing the network configuration, it can be made into a small chip. Through this, the mounted device may be mounted at various positions in various ways according to the purpose of use, thereby possibly increasing the degree of freedom in design. In addition, since expensive processors are not required to perform traditional deep learning algorithms, high resolution images can be produced more economically. Optimized parameters can be updated by sending them to the chip from the outside, and also they can be implemented as a black box so that they cannot be known from the outside by storing them inside the chip. By processing with Bayer data, it can be optimized by utilizing the amount of data processing and the linear characteristics of Bayer data.

In addition, by inserting into a connection part between the camera (CIS, camera image sensor) and the AP in the form of a bridge, the size issue or design issue between the camera and the AP can be reduced, and the heat issue between the camera and the AP can also be reduced. Although there is a chip design constraint due to the size inside the camera, since there is a relatively free space around the AP, when it is added to the connection part, the chip size constraint is also reduced, thereby reducing the chip design constraint. In addition, when it is separated from the camera, the f-cost can be reduced since the camera manufacturer also manages the defects separately.

In addition, the overall cost of the module is reduced because the cost for MIPI IP is reduced due to the integration with the sensor, and for that much, it becomes possible to supply modules to customers at low cost. In addition, since various data information shared inside the sensor is shared in the chip, AP control signals can also be unified for communication, and accordingly, memory can also be saved by using an EEPROM or a flash memory already in the sensor. Simple ISP functions are also included in the sensor, and if these functions are controlled analogously and used for image data, more diverse deep learning image databases can be created, thereby possibly improving the final performance.

### BRIEF DESCRIPTION OF DRAWINGS

FIG. 1 is a block diagram of an image processing module according to an embodiment of the present invention.

FIGS. 2 to 6 are diagrams for explaining an image processing process according to an embodiment of the present invention.

FIG. 7 is a block diagram of an image processing module according to another embodiment of the present invention.

FIG. 8 is a block diagram of a camera module according to an embodiment of the present invention.

FIGS. 9 and 10 are block diagrams of a camera module according to another embodiment of the present invention.

FIG. 11 is a block diagram of an image processing module according to another embodiment of the present invention.

FIGS. 12 and 13 are diagrams for explaining an image processing module according to the embodiment of FIG. 11.

FIG. 14 is a block diagram of a camera device according to an embodiment of the present invention.

FIG. 15 is a block diagram of an image sensor according to an embodiment of the present invention.

FIG. 16 is a diagram for explaining an image sensor according to an embodiment of the present invention.

FIGS. 17 and 18 are block diagrams of an image sensor according to another embodiment of the present invention.

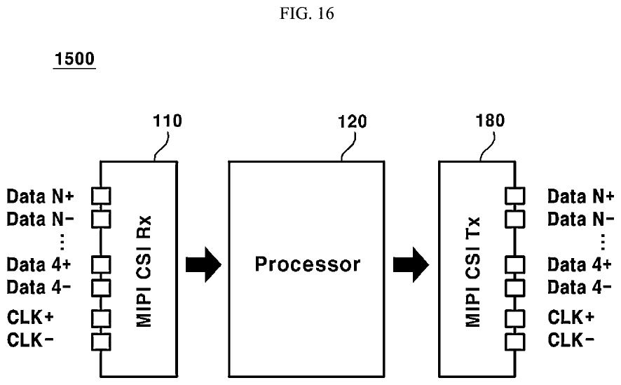

FIG. 16 is a diagram for explaining an image sensor according to another embodiment of the present invention.

FIG. 20 is a flowchart of an image processing method according to an embodiment of the present invention.

FIGS. 21 and 22 are flowcharts of an image processing method according to another embodiment of the present invention.

### BEST MODE

Hereinafter, preferred embodiments of the present invention will be described in detail with reference to the accompanying drawings.

However, the technical idea of the present invention is not limited to some embodiments to be described, but may be implemented in various forms, and within the scope of the technical idea of the present invention, one or more of the constituent elements may be selectively combined or substituted between embodiments.

In addition, the terms (including technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention.

In the present specification, the singular form may include the plural form unless specifically stated in the phrase, and when described as “at least one (or more than one) of A and B and C”, it may include one or more of all combinations that can be combined with A, B, and C.

In addition, in describing the components of the embodiment of the present invention, terms such as first, second, A, B, (a), and (b) may be used. These terms are merely intended to distinguish the components from other components, and the terms do not limit the nature, order or sequence of the components.

And, when a component is described as being ‘connected’, ‘coupled’ or ‘interconnected’ to another component, the component is not only directly connected, coupled or interconnected to the other component, but may also include cases of being ‘connected’, ‘coupled’, or ‘interconnected’ due that another component between that other components.

In addition, when described as being formed or arranged in “on (above)” or “below (under)” of each component, “on (above)” or “below (under)” means that it includes not only the case where the two components are directly in contact with, but also the case where one or more other components are formed or arranged between the two components. In addition, when expressed as “on (above)” or “below (under)”, the meaning of not only an upward direction but also a downward direction based on one component may be included.

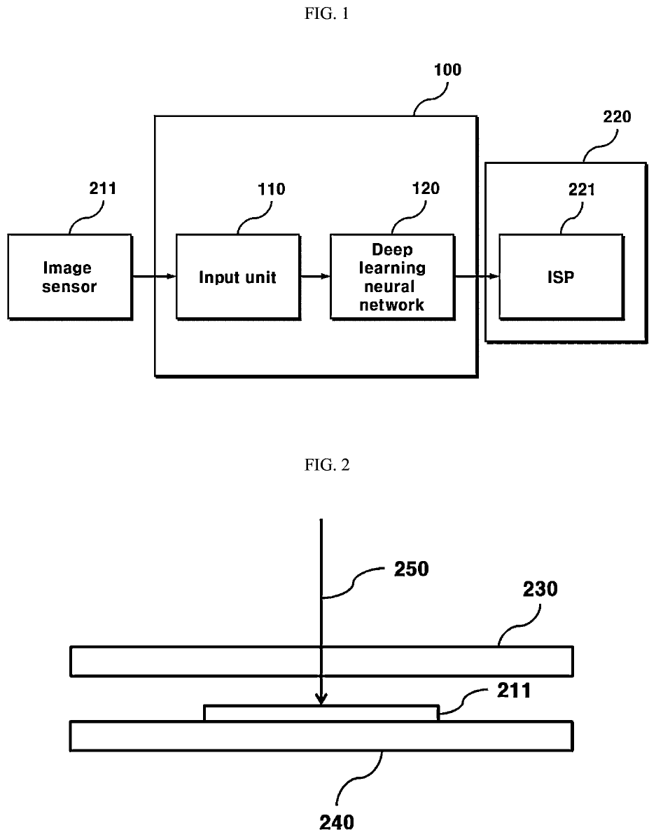

FIG. 1 is a block diagram of an image processing module 100 according to an embodiment of the present invention.

The image processing module 100 according to an embodiment of the present invention comprises an input unit 110 and a deep learning neural network 120, and may include a memory, a processor, and a communication unit.

The input unit 110 receives a first image data being generated using a light transmitted through a display panel.

More specifically, the input unit 110 receives a first image data to be image processed through a deep learning neural network 120. Here, the first image data is an image data being generated using a light transmitted through a display panel, and may receive a first image data from the image sensor 211 being disposed under a display panel. A camera in which the image sensor 211 is disposed under the display panel is referred to as an under display camera (UDC).

In a under display camera (UDC), the image sensor 211 may be disposed under the display panel 230 as shown in FIG. 2. It is disposed on the substrate 240 positioned under the display panel 230 and receives the light 250 transmitted through the display panel from the outside of the display panel to generate a first image data. Here, the image sensor 211 may include an image sensor such as a complementary metal oxide semiconductor (CMOS) or a charge coupled device (CCD) that converts light entering through a lens of a camera module disposed under the display panel 230 into an electrical signal.

Here, the first image data may be a Bayer data. Here, the Bayer data may include a raw data being outputted by the image sensor 211 that converts a received optical signal into an electrical signal.

To explain this in detail, the optical signal transmitted through the lens included in the camera module may be converted into an electrical signal through each pixel disposed in the image sensor capable of detecting colors of R, G, and B. For example, if the specification of the camera module is 5 million pixels, it can be considered that an image sensor including 5 million pixels capable of detecting colors of R, G, and B is included. Although the number of pixels of the image sensor is 5 million, it can be seen that each pixel does not actually detect all colors, but monochrome pixels that detect only the brightness of black and white are combined with any one of R, G, and B filters.

That is, in the image sensor, R, G, and B color filters are disposed in a specific pattern on monochromatic pixel cells arranged as many as the number of pixels. Accordingly, the R, G, and B color patterns are disposed intersected with one another according to the user's (i.e., human) visual characteristics, and this is called a Bayer pattern.

The deep learning neural network 120 outputs a second image data from the first image data.

More specifically, the deep learning neural network 120 is a deep learning neural network learned to output a second image data from a first image data, and when the input unit 110 receives a first image data, a second image data is outputted from a first image data. Here, the second image data is image data from which at least a portion of noise, which is an image quality degradation phenomenon that occurs when the light transmits through the display panel, is removed.

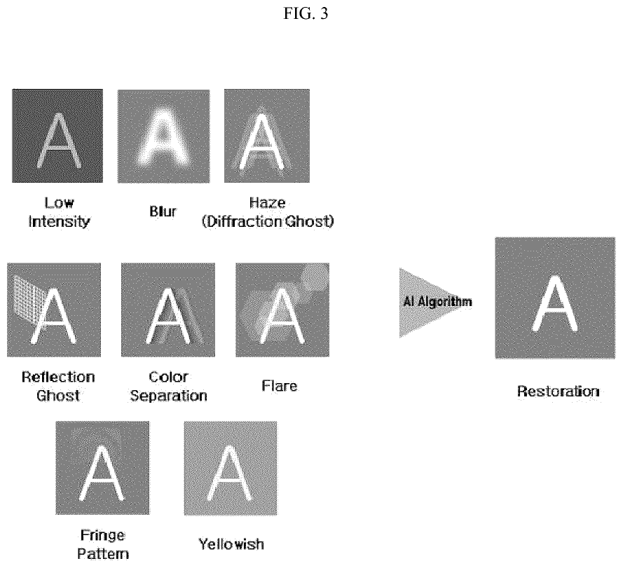

The image sensor 211 is disposed under the display panel, so that a light received by the image sensor 211 transmits through the display panel, and thus, when the light transmits through the display panel, image quality deterioration occurs. As the light transmits through the display panel, the amount of light drops sharply, and when high gain is used to make it up, noise is generated, but to remove this, processing with SW or ISP in AP will blur the image. In addition, due to the pattern of the display panel, an image quality degradation phenomenon occurs compared to the case in which a light not transmitted through the display panel, and various noises are included as shown in FIG. 3.

Here, the noise may include at least one among a low intensity, a blur, a haze (diffraction ghost), a reflection ghost, a color separation, a flare, a fringe pattern, and a yellowish phenomenon. A low intensity is a phenomenon in which the image quality is deteriorated due to low light intensity, a blur is a phenomenon in which the focus of an image is defocused, and a haze is a phenomenon in which diffraction ghost occurs and is a phenomenon in which a phantom image is generated like astigmatism, a reflection ghost is a phenomenon in which the pattern on the display panel is reflected to create a phantom image, a color separation is a phenomenon in which RGB colors are separated, a flare is a phenomenon in which bright areas excessively appearing due to internal reflection or diffuse reflection occur, a fringe pattern means a pattern caused by interference, and a yellowish phenomenon is a phenomenon in which the image appears to be yellowish. In addition, various noises may be included.

In order to improve such an image including noise, real-time performance as well as improvement effect is important. In particular, in the user terminal, real-time performance of the front camera is more important than the rear camera. The rear camera is usually used for photographing other places, so the quality of general photographing is more important than a video, and the photo mode is the most frequently used. However, since the front camera is more frequently used in camera modes that require real-time performance, such as video calls and personal broadcasting, rather than taking photos, fast processing speed with low power consumption is essential, however, there is a limit in fast processing of a high-resolution mobile image data with low power consumption by using software.

The deep learning neural network 120 may quickly improve the noise included in a first image data by using a deep learning neural network being learned to output a second image data from which at least some of the noise is removed from the first image data including the noise.

The second image data being outputted through the deep learning neural network 120 may have a different noise level from the first image data. Even though all the noise included in the first image data cannot be removed through the deep learning neural network 120 as in the case of including a noise not being learned, the noise level can be lowered by removing at least a portion of noise.

The deep learning neural network 120 is learned through deep learning. Deep learning, also referred to as deep structured learning, refers to a set of algorithms related to machine learning that attempts high level abstraction (a task that summarizes core contents or functions in large amounts of data or complex data) through a combination of several nonlinear transformation methods.

Specifically, deep learning expresses any learning data in a form that a computer can understand (for example, in the case of an image, pixel information is expressed as a column vector, and the like), and is a learning technique for a lot of research (how to make a better representation technique and how to make a model to learn these) to apply these to learning, and may include learning techniques such as deep neural networks (DNN) and deep belief networks (DBN).

As an example, deep learning may first recognize the surrounding environment and transfer the current environment state to the processor. The processor performs an action appropriate to this and the environment again informs the processor of the reward for the action.

And the processor chooses the action that maximizes the reward. Through this process, the learning process may proceed repeatedly. As previously described, the learning data being used while performing deep learning may be a result obtained by converting a Bayer image with a low actual resolution into a Bayer image with a high resolution, or may be information obtained through simulation. In a case when the simulation process is performed, data can be acquired more quickly by adjusting it according to the environment of the simulation (the background of the image, the type of color, and the like).

Deep learning includes a deep neural network (DNN), and the deep neural networks (DNN) may be specified as: a deep neural network in which multiple hidden layers exist between an input layer and an output layer; a convolutional neural network that forms a connection pattern between neurons similar to the structure of the visual cortex of animals; and a recurrent neural network that builds up a neural network at every moment over time. Convolutional neural networks may be at least one model among a fully convolutional network (FCN), a U-Net, a MobileNet, a residual dense network (RDN), and a residual channel attention network (RCAN). It is natural that various other models can be used.

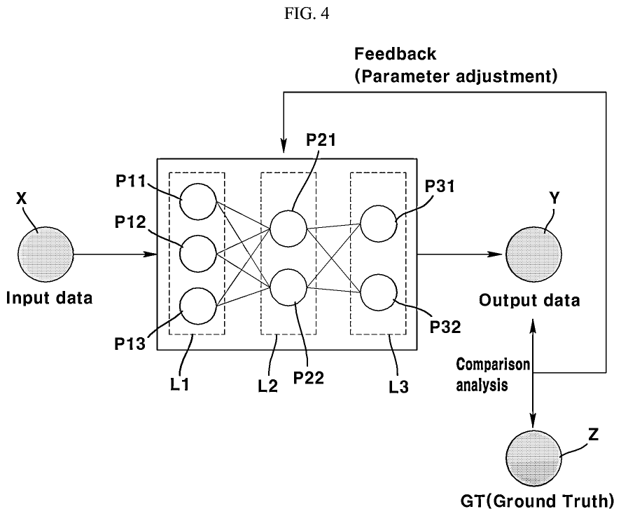

Training of the deep learning neural network 120 is performed based on a first image data being generated using a light transmitted through a display panel; and a training set including a second image data being generated using a light that does not transmitted through a display panel. The deep learning neural network 120 is learned to output a second image data based on a first image data. Deep learning training may be performed through a process as shown in FIG. 4.

Training for the deep learning neural network 120 may be performed through repetitive training as shown in FIG. 4. Training is carried out for a first image data being generated using a light transmitted through a display panel and a second image data being generated using a light that not transmitted through a display panel. Here, the first image data is inputted to the deep learning neural network as input data X, and the second image data serves to compare the output data Y being outputted from a deep learning neural network as a ground truth (GT) Z. Ground truth (GT) means the most ideal data that can be generated in a deep learning neural network during training. The deep learning neural network is repeatedly trained so that the output data Y approaches GT Z.

Here, the first image data may be an image data generated by an image sensor photographing a specific object when a display panel is applied, and the second image data may be an image data generated by an image sensor photographing the same object when a display panel is not applied. At this time, in order to generate Bayer data for the same scene, a device capable of being fixed, such as a tripod, to a camera device including an image sensor may be used. Using two image data as a training set, iterative training is performed for a preset time or more and a preset number or more training sets.

Training may be performed using a loss function and an optimizer. It receives the input data X and compares and analyzes the output data Y and GT Z being outputted by the deep learning neural network and adjusts the parameters using the loss function and the optimizer and iteratively trains so that the output data Y approaches GT Z.

The output data Y and GT Z being outputted according to the input of the input data X1 and the noise level X2 are compared and analyzed to calculate the difference between the two data, and a feedback can be given to the parameters of the convolution filter in a way that the difference between the two data is being reduced. At this time, the difference between the two data can be calculated through the MSE (Mean Squared Error) method, which is the mean square error, which is one of the loss functions. In addition, various loss functions such as CEE (Cross Entropy Error) can be used. After analyzing parameters that affect output data, feedback can be provided by changing or deleting parameters or creating new parameters so that there is no difference between GT (Z) and the output data (Y), which is the actual output data.

As illustrated in FIG. 4, for an example, it may be assumed that there are a total of 3 layers L1, L2, and L3 that affect the algorithm, and there are a total of 8 parameters P11, P12, P13, P21, P22, P31, and P32 in each layer. In this case, if the difference between the output data Y and the GT Z is increased when the parameter is changed in the direction of increasing the value of the parameter P22, the feedback is learned to change the algorithm in the direction of decreasing the parameter P22. Conversely, if the difference between the output data Y and GT Z decreases when the parameter is changed in the direction of increasing the value of the parameter P33, the feedback is learned to change the algorithm in the direction of increasing the P33 parameter.

In deep learning training, as shown in FIG. 4, when an output result and a comparison target exist, and learning is performed through comparison with the comparison target, training can also be performed using a reward value. In this case, it is possible to first recognize the surrounding environment and transmit the current environment state to a processor that performs deep learning training. The processor performs an action corresponding to it, and the environment informs the processor of the reward value according to the action again. And the processor takes the action that maximizes the reward value. Training can be performed by repeatedly performing learning through this process. In addition, deep learning training can be performed using various deep learning training methods.

As previously described, parameters of each convolutional layer being derived through training are applied to the deep learning neural network 120 as shown in FIG. 5 to output a second image data from a first image data. The parameter applied to each convolutional layer may be a fixed parameter derived through training, or a variable parameter that is updated through training or varies according to other conditions or instructions. The parameter value may be stored in the memory or a parameter being externally stored in an AP or a device, a server, or the like performing deep learning training may be received and used during operation or turn-on.

Deep learning-based algorithms for realizing image data with improved noise generally use a frame buffer, which may be difficult to run in real time in general PCs and servers due to its characteristics.

However, since the deep learning neural network 120 applies an algorithm already generated through deep learning training, it can be easily applied to a low-spec camera module and various devices including the same, and in a specific application of these deep learning neural networks, since high resolution is implemented in a way that uses only a few line buffers, so there is also an effect that a processor can be implemented with a relatively small chip.

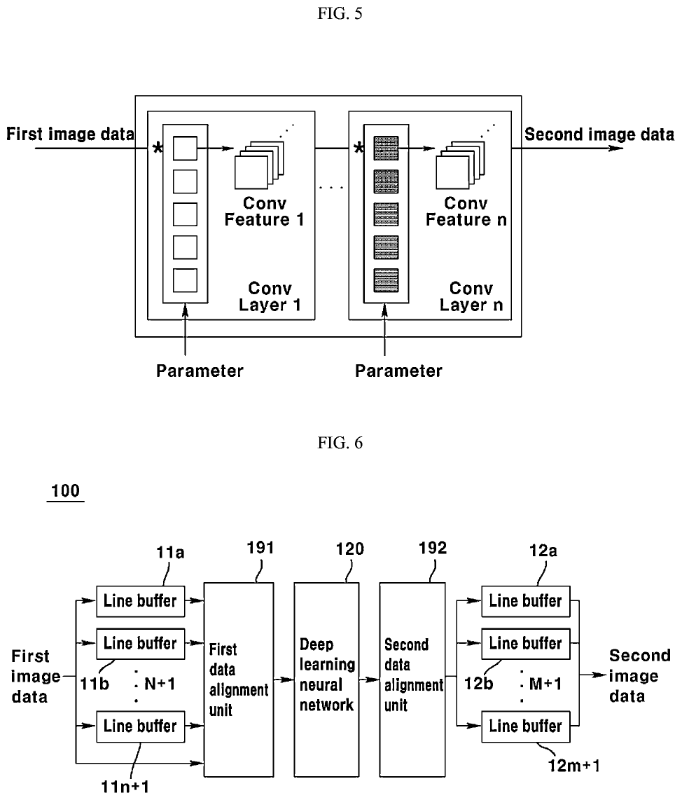

Referring to FIG. 6, the deep learning neural network 120 may comprise: a plurality of line buffers 11 for receiving a first image data; a first data alignment unit 221 for generating a first array data for arranging the first image data outputted through the line buffers for each wavelength band; a deep learning neural network 120 for processing images through a deep learning neural network being learned; a second data alignment unit 192 for generating a second image data by arranging the second array data outputted through the deep learning neural network 120 in a Bayer pattern; and a plurality of line buffers 12 for outputting a second image data outputted through the second data alignment unit 192.

The first image data is information including the Bayer pattern described previously, and it may be defined as a Bayer data or an RGB image. In addition, the first data alignment unit 191 and the second data alignment unit 192 are illustrated as separate components for convenience, but are not limited thereto, and the deep learning neural network 120 may perform functions performed by the first data alignment unit 191 and the second data alignment unit 192 together.

A first image data received by the image sensor 211 may transmit image information on an area selected by the user to n+1 line buffers 11a, 11b, . . . , 11n, and 11n+1. As described previously, since a second image data is generated only for the area selected by the user, image information on an area not selected by the user is not transmitted to the line buffer 11. Specifically, the first image data includes a plurality of row data, and the plurality of row data may be transmitted to the first data alignment unit 191 through the plurality of line buffers 11.

For example, if the area in which deep learning is to be performed by the deep learning neural network 120 is a 3×3 area, a total of three lines must be simultaneously transmitted to the first data alignment unit 191 or the deep learning neural network 120 to perform deep learning. Accordingly, information on the first line among the three lines is transmitted to the first line buffer 11a and then stored in the first line buffer 11a, and information on the second line among the three lines is transmitted to the second line buffer 11b and then may be stored in the second line buffer 11b.

After that, in the case of the third line, since there is no information on the line received thereafter, it may not be stored in the line buffer 11 and may be directly transmitted to the deep learning neural network 120 or the first data alignment unit 191. At this time, since the first data alignment unit 191 or the deep learning neural network 120 must simultaneously receive information on three lines, the information on the first line and the information on the second line stored in the first line buffer 11a and the second line buffer 11b may be simultaneously transmitted to the deep learning neural network 120 or the first image alignment unit 191.

Conversely, if the area where deep learning is to be performed by the deep learning neural network 120 is an (N+1)×(N+1) area, only when a total of N+1 lines is simultaneously transmitted to the first data alignment unit 191 or to the deep learning neural network 120 to perform deep learning. Accordingly, information on the first line among N+1 lines is transmitted to the first line buffer 11a and then stored in the first line buffer 11a, information on the second line among N+1 lines may be transmitted to the second line buffer 11b and then stored in the second line buffer 11b, and information on the Nth line among N+1 lines may be transmitted to the Nth line buffer 11n and then stored in the Nth line buffer 11n.

After that, in the case of the (N+1) th line, since there is no information about the line being received thereafter, it is not stored in the line buffer 11 and may be directly transmitted to the deep learning neural network 120 or the first data alignment unit 191, and as described previously, at this time, since the first data alignment unit 191 or the deep learning neural network 120 must simultaneously receive information on N+1 lines, information on the first to nth lines stored in the line buffers 11a to 11n may also be simultaneously transmitted to the deep learning neural network 120 or the first image alignment unit 219.

After receiving Bayer data from the line buffer 11, the first image alignment unit 219 generates first array data by arranging Bayer data for each wavelength band, and then may transmits the generated first array data to the deep learning neural network 120. The first image alignment unit 219 may generate first array data arranged by classifying the received information into specific wavelengths or specific colors (red, green, and blue).

Thereafter, the deep learning neural network 120 may generate a second sequence data based on a first sequence data received through the first image alignment unit 219. The deep learning neural network 120 may generate a second sequence data by performing deep learning based on the first sequence data received through the first data alignment unit 191.

For example, as described previously, when first array data is received for a 3×3 area, deep learning is performed for the 3×3 area, and when first array data is received for the (n+1)×(n+1) area, deep learning may be performed for the (n+1)×(n+1) area.

Thereafter, the second array data generated by the deep learning neural network 120 is transmitted to the second data aligning unit 192, and the second data aligning unit 192 may convert the second array data into second image data. Thereafter, the converted second image data may be externally outputted through the plurality of line buffers 12a.

At least one of the first image data and the second image data may be a Bayer image data. Both the first image data and the second image data may be Bayer data, the first image data may be a Bayer data and the second image data may be an RGB data, or both the first image data and the second image data may be an RGB data.

As previously described, a Bayer data is a raw data, and the amount of data is smaller than image data such as RGB data. Therefore, advantages exist in that even a device equipped with a camera module that does not have a high-end processor can transmit and receive image information of a Bayer pattern relatively faster than data in the form of an image, and based on this, it may be converted into an image with various resolutions. For an example, in an environment in which a camera module is mounted on a vehicle and a low-voltage differential signaling (LVDS) having a full-duplex transmission speed of 100 Mbit/s is used, the camera module is not overloaded since image processing does not require many processors so that it may not endanger the safety of the driver or the driver using the vehicle. In addition, since it is possible to reduce the size of data transmitted by the in-vehicle communication network, there is an effect in that even when applied to an autonomous vehicle it is possible to eliminate problems caused by the communication method and communication speed according to the operation of a plurality of cameras placed in the vehicle.

The second image data may be outputted to an image signal processor (ISP) 221. The image signal processor 221 may receive the second image data being outputted from the deep learning neural network 120 using a mobile industry processor interface (MIPI) communication and perform an image signal processing process. The ISP 221 may include a plurality of sub-processes while processing an image signal. For example, the received image may include one or more of gamma correction, color correction, auto exposure correction, and auto white balance processes.

The ISP 221 may be included in the AP module 220. The application processor (AP) module 220 is a mobile memory chip and refers to a core semiconductor in charge of various application operations and graphic processing in a mobile terminal. The AP module 220 may be implemented in the form of a system on chip (SoC) that includes both the functions of the central processing unit (CPU) of the computer and the functions of the chipset to control the connection of memory, hard disk, graphic card, and the like.

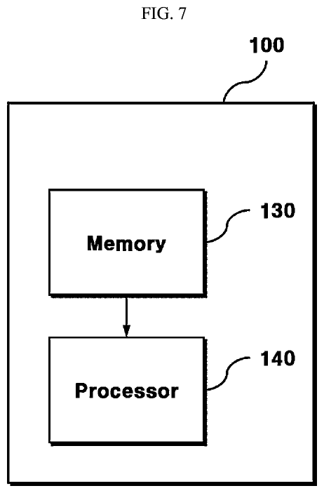

The image processing module 100 according to an embodiment of the present invention may include at least one processor 140 and a memory 130 for storing instructions processed by the processor 140 as shown in FIG. 7. A detailed description of the image processing module 100 of FIG. 7 corresponds to a detailed description of the image processing module of FIGS. 1 to 6, and an overlapping description will be omitted hereinafter. The processor 140 receives first image data being generated using a light transmitted through the display panel according to an instruction stored in the memory 130, and outputs a second image data from a first image data. Here, the second image data is image data from which at least a portion of noise, which is an image quality degradation phenomenon that occurs when the light transmits through the display panel, is removed. The processor 140 includes a deep learning neural network, and the training set of the deep learning neural network may include a first image data being generated using a light transmitted through a display panel and a second image data being generated using a light not transmitted through a display panel.

The image sensor module 210 according to an embodiment of the present invention includes an image sensor 211, a driver IC 215, and an image processing module 100, and may include a filter 212, a lens 213, and an actuator 214. The image sensor module 210 according to an embodiment of the present invention may be a camera module being disposed under a display panel. A detailed description of each configuration of the image sensor module 210 according to an embodiment of the present invention corresponds to a detailed description of each corresponding configuration of the image processing module of FIGS. 1 to 7, and the overlapping description will be omitted hereinafter.

The filter 212 serves to selectively block a light being introduced from the outside, and may be generally located above the lens 213. The lens 213 is a device in which the surface of a transparent material such as glass is finely grinded into a spherical surface to collect or emit light from an object to form an optical image, and a general lens being used in the image sensor module 210 may be provided with a plurality of lenses having different characteristics from one another.

The driver IC 215 refers to a semiconductor IC that provides driving signals and data as electrical signals to the panel so that characters or video images are displayed on the screen, and as will be described later, the driver IC 215 may also drive the actuator 214.

The actuator 214 may adjust the focus by adjusting the position of the lens or the barrel including the lens. For example, the actuator 214 may be a voice coil motor (VCM) type. The lens 213 may include a variable focus lens. When the variable focus lens is included, the driver IC 215 may drive the variable focus lens. For example, the lens 213 may include a liquid lens containing a liquid. In this case, the driver IC 215 may adjust the focus by adjusting the liquid of the liquid lens.

The image processing module 100 may be formed as a single chip with the driver IC 215 or as a separate chip. Or, it may be formed as a module separate from the image sensor module 210.

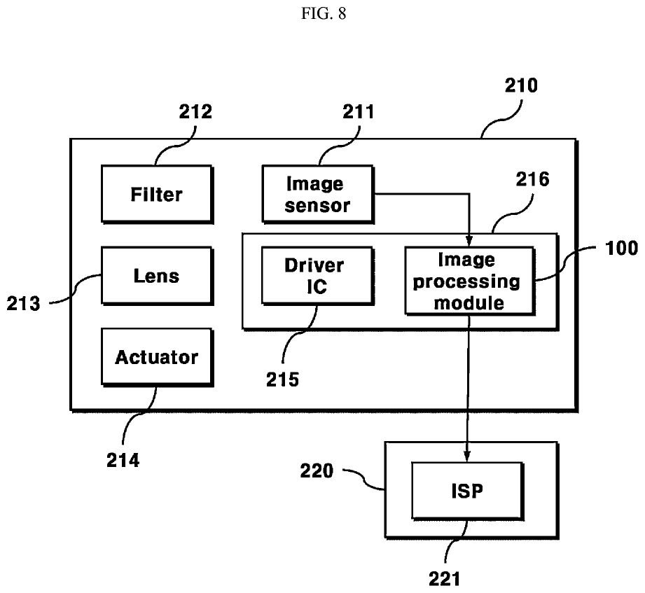

First, as shown in FIG. 8, the image processing module 100 may be formed as a single package with one chip 216 with a driver IC 215. By forming a single chip 216 with the driver IC basically included in the image sensor module 210, the function of the driver IC and the function of the image processing module can be simultaneously performed, which is economical.

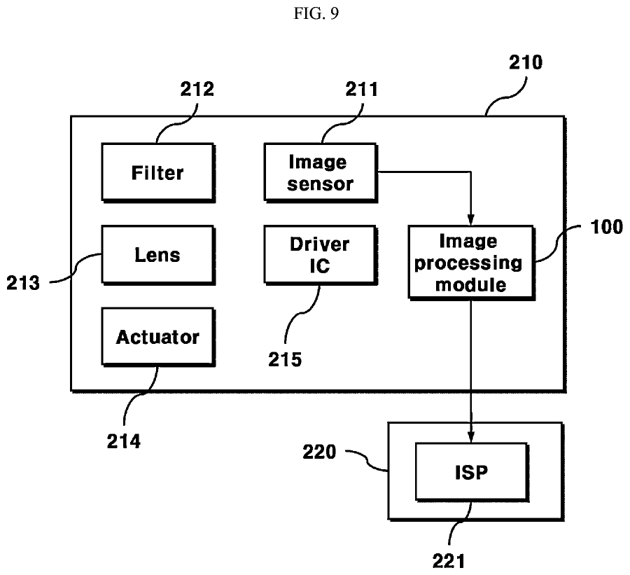

Or, as shown in FIG. 9, the image processing module 100 is formed inside the image sensor module 210, but may be formed as two packages with a separate chip from the driver IC 215. Only the image processing module 100 may be additionally disposed and used without changing the structure of the image sensor module 210. Through this, it is possible to prevent a decrease in the degree of freedom in design when forming a single chip with the driver IC, and the process for generating the chip can also be made easier compared to the case where it is formed into a single chip.

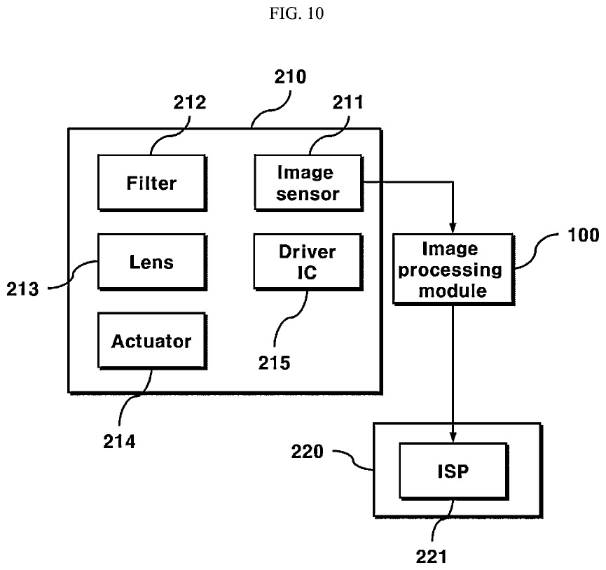

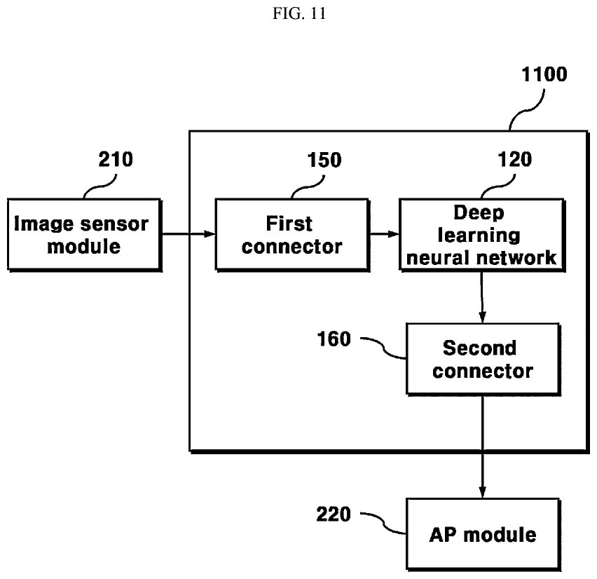

Or, as shown in FIG. 10, the image processing module 100 may be formed outside the image sensor module 210. By disposing only the image processing module 100 between the image sensor module 210 and the AP module 220 without changing the image sensor module 210, the degree of freedom in design can be increased. Or, the image processing module 100 may be disposed in the AP module 220 instead of the image sensor module 210.

As described previously, low power consumption and fast processing are possible through the image processing module 100 including the deep learning neural network 120. It is possible to process with low power consumption while driving in real time by using a HW accelerator rather than applying a SW algorithm. Most of them are multiplexing HW, which is a deep learning based technology that is easy to optimize with a HW accelerator.

Most of the deep learning based algorithms use frame buffers, so it may be difficult to run them in real time in general PCs and servers, but in the present invention, only a few line buffers are used, and the network configuration is optimized so that it can be made into a small chip.

Since miniaturization becomes possible, it can be formed in various arrangements for the image sensor module.

Deep learning training is performed to remove the image quality degradation phenomenon caused by the panel from the first image data being disposed under a display panel and including noise which is an image quality degradation phenomenon, then it can be operated in real time using the optimized parameters extracted through learning. The optimized parameters can be updated by sending them to the chip from the outside, and also they can be implemented as a black box so that they cannot be known from the outside by storing them inside the chip. By processing with Bayer data, it can be optimized by utilizing the amount of data processing and the linear characteristics of Bayer data.

FIG. 11 is a block diagram of an image processing module according to another embodiment of the present invention.

The image processing module 1100 according to another embodiment of the present invention includes a first connector 150, a deep learning neural network 120, and a second connector 160. Since the detailed description of the deep learning neural network 120 of FIG. 11 corresponds to the detailed description of the deep learning neural network 120 of FIGS. 1 to 10 about the process of outputting a second image data from a first image data being generated using a light transmitted through a display panel, the overlapping descriptions will be omitted hereinafter.

The first connector 150 is connected to the image sensor module 210 to receive first image data, and a deep learning neural network 120 for outputting second image data from the first image data being received through the first connector 150 and a second connector 160 being connected to an application processor (AP) module 220 to output the second image data are included.

When the image processing module 1100 is disposed inside the image sensor module 210 or the AP module 220, the size of the image sensor module 210 or the AP module 220 may be increased, and the heat being generated by the image processing module 1100 may be transferred to the image sensor module 210 or the AP module 220 to affect the image sensor module 210 or the AP module 220. As shown in FIG. 11, since the image processing module 1100 is connected to the image sensor module 210 and the AP module 220 through the first connector 150 and the second connector 160, respectively, it is possible to prevent size increase or heat generation.

The first connector 150 and the second connector 160 are respectively connected to the image sensor module 210 and the AP module 220 to form a bridge between the image sensor module and the AP module. The first connector 150 and the second connector 160 mean a physical connector, and a port conforming to a communication standard for transmitting and receiving data may be formed. Each connector may be a communication connector for MIPI communication. The connectors 150 and 160 may be implemented as a rigid substrate or a flexible substrate.

The image processing module 1100 may be disposed on the same substrate as at least one of the image sensor module 210 and the AP module 220. At this time, the image sensor module or the AP module may be spaced apart from each other.

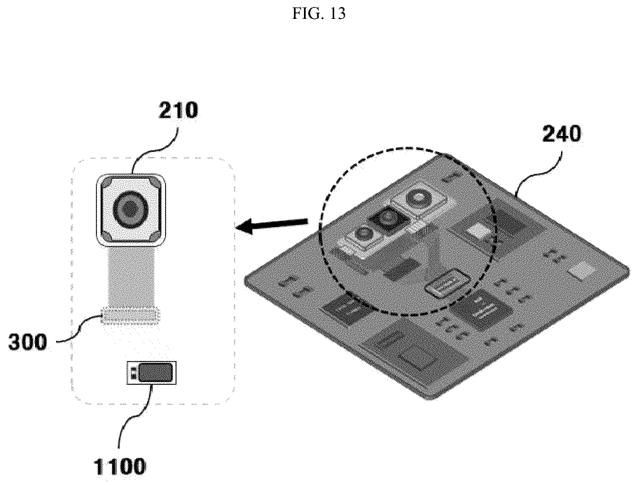

As shown in FIG. 13, the image processing module 1100 may be connected to the connector 300 of the image sensor module 210 in a bridge form on the same substrate 240 as the image sensor module 210. It is possible to reduce the size issue or design issue of the image sensor module 210 and the AP module 220 by being disposed in the form of a bridge in a connection part between the image sensor module 210 and the AP module 220, and the heat issue of the image sensor module 210 and the AP module 220 may also be reduced. There is a chip design constraint due to the size inside the camera including the image sensor module 210, but since there is a relatively free space around the AP module 220 on the board, when added in the form of a bridge, the chip size constraint is also reduced, thereby reducing the chip design constraint. In addition, when the image sensor module 210 is separated, the camera manufacturer also manages the defects separately, thereby possibly reducing the f-cost.

In addition, the image sensor module 210 may be disposed under a display panel. At this time, the first image data is image data being generated using a light transmitted through a display panel, and the second image data may be an image data from which at least a portion of noise, which is an image quality degradation phenomenon that occurs when the light transmits through a display panel, is removed. Here, the noise may include at least one among a low intensity, a blur, a haze (diffraction ghost), a reflection ghost, a color separation, a flare, a fringe pattern, and a yellowish phenomenon.

At this time, the training set of the deep learning neural network may include a first image data being generated using a light transmitted through a display panel and a second image data being generated using a light not transmitted through a display panel.

In addition, the first image data is an image data having a first resolution, and the second image data may be an image data having a second resolution. At this time, the deep learning neural network 120 of the image sensor module 210 may be trained to output second image data having a second resolution from the first image data having a first resolution. Here, the first resolution may be higher than the second resolution. Conversely, the first resolution may be lower than the second resolution. At this time, the training set of the deep learning neural network may include a first image data having a first resolution and a second image data having a second resolution. At least one of the first image data and the second image data is a Bayer image data.

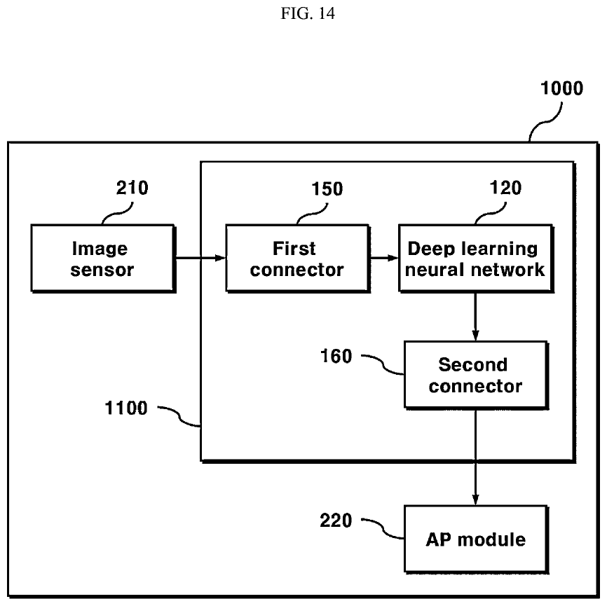

FIG. 14 is a block diagram of a camera device according to an embodiment of the present invention.

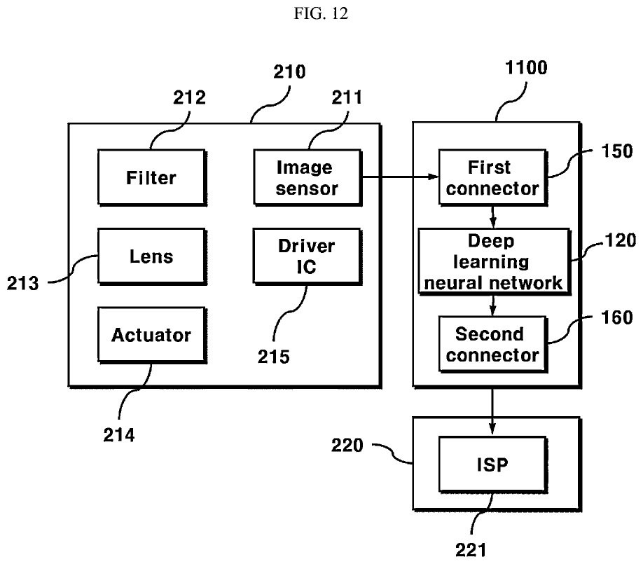

The camera device 1000 according to an embodiment of the present invention comprises: an image sensor module 210 for generating a first image data; an image processing module 1100 including a deep learning neural network for receiving a first image data from an image sensor and outputs a second image data from the first image data; and an application processor (AP) module 220 for receiving a second image data from the deep learning neural network and generating an image from the second image data, wherein the image processing module 1100 includes a first connector being connected to the image sensor and a second connector being connected to the AP module to connect the image sensor and the AP module, and wherein at least one of the image sensor and the AP module is disposed on a same substrate and spaced apart from each other. Since the detailed description of each configuration of the camera device 1000 according to the embodiment of the present invention in FIG. 14 corresponds to the detailed description of each corresponding configuration in FIGS. 1 to 13, hereinafter, overlapping descriptions will be omitted.

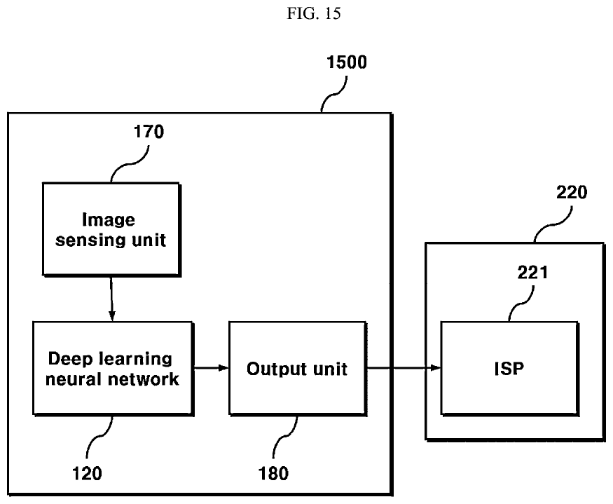

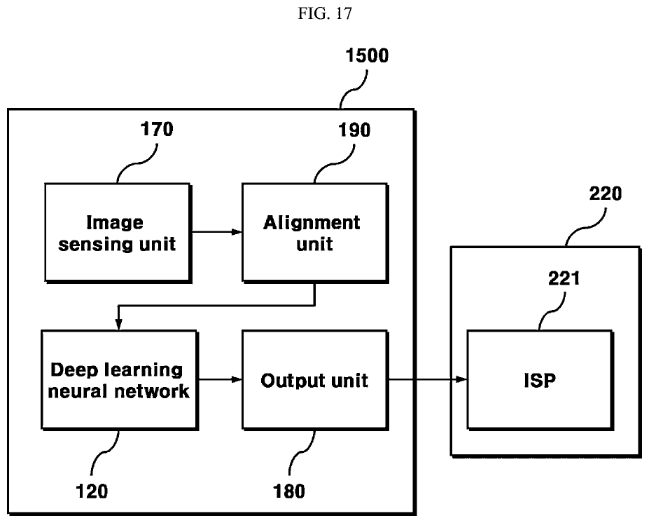

FIG. 15 is a block diagram of an image sensor according to an embodiment of the present invention; and FIG. 16 is a diagram for explaining an image sensor according to an embodiment of the present invention. A detailed description of each configuration of FIGS. 15, 17, and 18 corresponds to a detailed description of each corresponding configuration of FIGS. 1 to 14, hereinafter, overlapping descriptions will be omitted.

The image sensor 1500 according to an embodiment of the present invention comprises: an image sensing unit 170 for generating a first image data by using a light transmitted through a display panel; a deep learning neural network 120 for outputting a second image data from the first image data; and an output unit 180 for transmitting the second image data to the outside, wherein the deep learning neural network outputs a second image data according to the output format of the output unit.

The image sensing unit 170 may be disposed under a display panel to generate a first image data using a light transmitted through a display panel. The deep learning neural network 120 generates a second image data from the first image data. Here, the second image data may be an image data from which at least a portion of noise, which is a quality degradation phenomenon that occurs when the light transmits through the display panel, is removed, and the noise may include at least one among a low intensity, a blur, a haze (diffraction ghost), a reflection ghost, a color separation, a flare, a fringe pattern, and a yellowish phenomenon. The training set of the deep learning neural network may include a first image data being generated using a light transmitted through a display panel and a second image data being generated using a light not transmitted through a display panel, and at least one of the image data and the second image data may be a Bayer image data.

The output unit 180 transmits the second image data to the outside, but transmits data conforming to the output format according to the communication standard with the outside. Accordingly, in outputting a second image data, the deep learning neural network 120 outputs the second image data according to the output format of the output unit 180. Here, the target for transmitting a second image data may be the ISP 221. The ISP 221 is disposed in the AP module 220, and may transmit and receive data to and from the image sensor 1500 in one of preset communication standards. For example, data may be transmitted and received through MIPI, and the deep learning neural network 120 may output a second image data according to the MIPI standard. In the case of using other communication standards, data corresponding to the output format can be outputted accordingly.

When the deep learning neural network 120 is formed separately from the image sensor 211, in order to connect the processor including the deep learning neural network 120 to communication between the image sensor 211 and the ISP, as shown in FIG. 16, a structure of ‘chip input MIPI rx and chip output MIPI tx’ is additionally required between the image sensor output MIPI tx and the AP input MIPI rx.

However, when implementing the deep learning neural network 120 in the image sensor 1500, since the second image data being generated by the deep learning neural network 120 may use the image sensor output instead of the chip output, there is an effect of making the design relatively simple.

That is, in the “image sensor output MIPI tx-chip input MIPI rx-chip output MIPI tx-AP input MIPI rx” structure of the image sensor 1500 of FIG. 15, the “chip input MIPI rx-chip output MIPI tx” part may be deleted. In addition, the cost of the MIPI IP can be reduced due to the integration with the image sensor 200, so that it can be manufactured economically, and the freedom of design can also be increased.

In addition, since various pieces of data information shared inside the image sensor 1500 are shared together in the chip, the control signal of the AP module 220 can also be unified and communicated, and memory can also be saved by using the EEPROM or Flash memory of the image sensor 1500 together.

In addition, since the image sensor 1500 also includes simple ISP functions, if these functions are utilized for image data, more diverse deep learning image databases can be created so that there is an effect that can improve the final performance.

The alignment unit 190 outputs a third image data by decomposing or rearranging at least a portion of the first image data, and at this time, the deep learning neural network 120 may output the second image data from the third image data. In order to efficiently process the data being outputted from the image sensing unit 170 in the deep learning neural network 120, the alignment unit 190 may output a third image data in the form of data suitable for the deep learning neural network 120 by decomposing or rearranging at least a portion of a first image data. The alignment unit 190 may output only the arrangement necessary to generate a second image data among a first image data as a third image data. The alignment unit 190 may serve as a line buffer.

In addition, the alignment unit 190 may output the third image data according to an output format of the output unit. Since the output unit 180 should output a second image data according to an output format, the first image data may be converted into third image data according to an output format in advance and outputted to the deep learning neural network 120. The deep learning neural network 120 can output directly without the need to separately generate a second image data according to an output format.

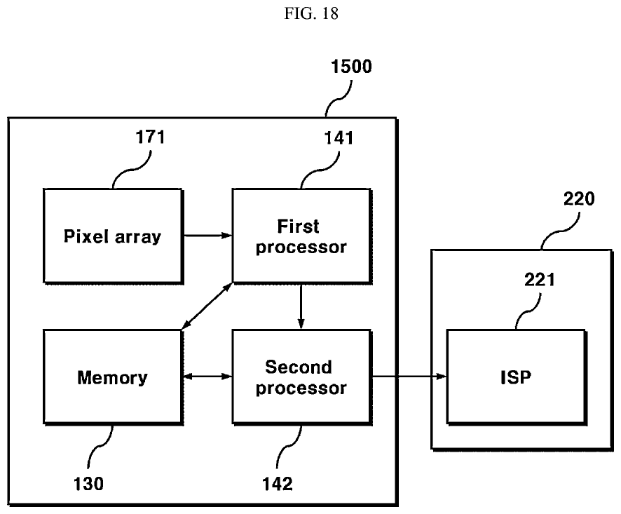

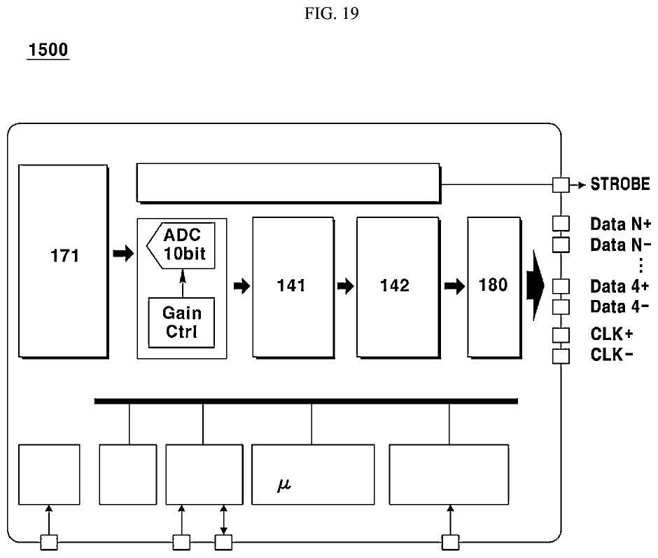

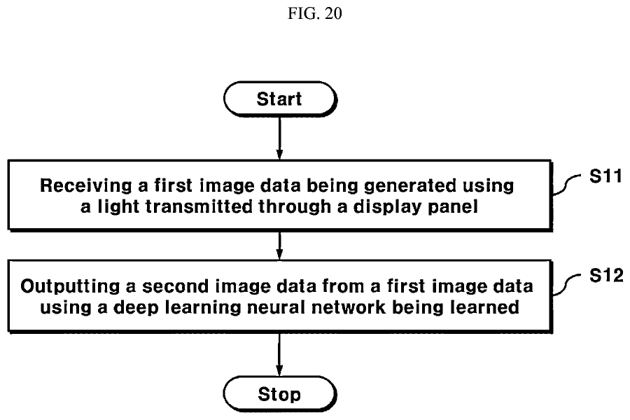

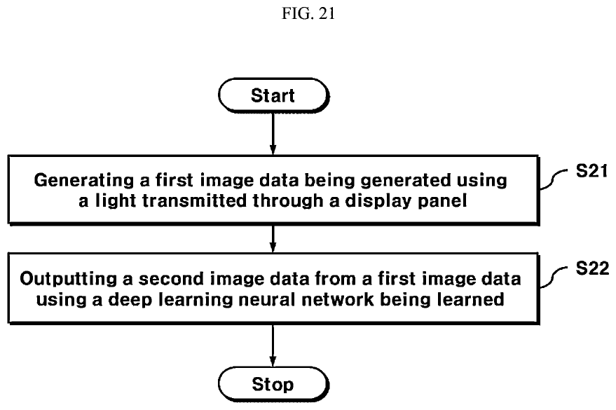

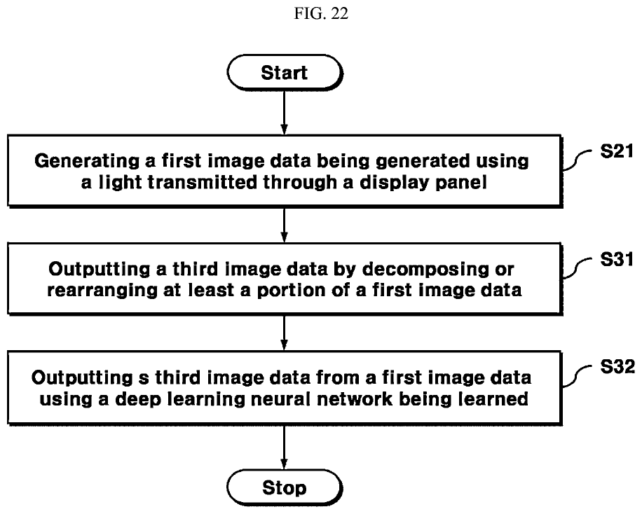

The image sensor 1500 according to another embodiment of the present invention, as shown in FIG. 18, comprises: a pixel array 171 for receiving a light transmitted through a display panel; a first processor 141 and a second processor 142; and a memory 130 for storing instructions being processed by the first processor 141 or the second processor 142, wherein the first processor 141 generates a first image data by using the output of the pixel array 171 according to an instruction stored in the memory 130, wherein the second processor 142 outputs a second image data from the first image data according to an instruction stored in the memory 130, wherein the second image data may be an image data in which at least a portion of noise, which is a picture quality degradation phenomenon that occurs when the light transmits through a display panel, is removed, and being outputted according to an output format.

The pixel array 171 outputs a filter value for each pixel through a filter for light being received by the image sensor. At this time, the signal being outputted from the pixel array 171, as shown in FIG. 19, is decoded through each decoder of the matrix and converted into a digital signal through an analog-to-digital converter. Thereafter, the first processor 141 generates a first image data from the signal converted into the digital signal. The second processor 142 including a deep learning neural network generates a second image data from the first image data, and outputs the second image data according to an output format through the output unit 180.

In addition, the image sensor 1500 may include a PLL, an OTP, an I2C, an internal LDO, and the like. A high speed MIPI interface should be utilized in order to send a high capacity image raw data, inputted from the image sensing unit 171 and processed after transmitted through an internal block and the like, to the AP. To this end, the image sensor 1500 may further include a phase locked loop (PLL) that performs frequency division and multiplication to achieve a speed of several Gbps. OTP means a memory space for storing the image sensing unit 171 and specific parameters of the SR algorithm, I2C is an interface being used to output an instruction according to a user's manipulation of the camera module 100 from the AP 300, and, in general, has a bus structure being connected by 2 lines SCL and SDA. In internal low drop out (LDO) & POR, the internal LDO may serve to supply power to the image sensing unit 171, and in the case of POR, it is possible to perform a reset function for smooth operation in a power saving mode at the same time as the operation instruction of the AP.

FIG. 20 is a flowchart of an image processing method according to an embodiment of the present invention; and FIGS. 21 and 22 are flowcharts of an image processing method according to another embodiment of the present invention. The detailed description in each step of FIGS. 20 to 22 corresponds to the detailed description of the image processing module, the camera module, and the image sensor of FIGS. 1 to 19 and therefore the overlapping description will be omitted hereinafter.

In order to remove at least a portion of noise, which is a picture quality degradation phenomenon that occurs when the light transmits through a display panel, first, in step S11, the image processing module 100 receives a first image data being generated by using a light transmitted through a display panel, in step S12, a second image data is outputted from the first image data using the deep learning neural network being learned. Here, the second image data is an image data from which at least a portion of noise, which is an image quality degradation phenomenon that occurs when a light transmits through a display panel, is removed. The training set of the deep learning neural network may include: a first image data being generated using a light transmitted through a display panel; and a second image data being generated using a light not transmitted through a display panel.

The first image data is received from the image sensor being disposed under a display panel, and the second image data may be outputted to an image signal processor.

In order to remove at least a portion of noise, which is an image quality degradation phenomenon that occurs when the light transmits through a display panel, from an image generated using the light transmitted through the display panel, The image sensor 211 generates a first image data using a light transmitted through a display panel in step S21, and outputs a second image data from the first image data using the deep learning neural network being learned in step S22. Here, the second image data is image data being outputted according to a communication format after at least part of noise, which is an image quality degradation phenomenon that occurs when the light transmits through the display panel, is removed.

After step S21, at least a portion of the first image data may be decomposed or rearranged in step S31 to output a third image data, and at this time, step S22 in which the second image data is outputted can be implemented as step S32 in which the second image data is outputted from the third image data. The second image data may be outputted to an image signal processor.

Meanwhile, the embodiments of the present invention can be implemented as computer-readable codes on a computer-readable recording medium. The computer-readable recording medium includes all types of recording devices in which data readable by a computer system is stored.

As examples of computer-readable recording media there are ROM, RAM, CD-ROM, magnetic tape, floppy disk, and optical data storage devices, and in addition, they are distributed across networked computer systems in a distributed manner in which computer-readable code can be stored and executed. And functional programs, codes, and code segments for implementing the present invention can be easily inferred by programmers in the technical field to which the present invention belongs.

As described above, in the present invention, specific matters such as specific components, and the like; and limited embodiments and drawings have been described, but these are only provided to help a more general understanding of the present invention, and the present invention is not limited to the above embodiments, and various modifications and variations are possible from these descriptions by those of ordinary skill in the art to which the present invention belongs.

Therefore, the spirit of the present invention should not be limited to the described embodiments, and not only the claims to be described later, but also all those with equivalent or equivalent modifications to the claims will be said to belong to the scope of the spirit of the present invention.

1. An image processing module comprising:
an input unit configured to receive first image data generated using light transmitted through a display panel; and
a deep learning neural network configured to output second image data from the first image data,
wherein the second image data is image data from which at least a portion of noise, which is a picture quality degradation phenomenon that occurs when the light transmits through the display panel, is removed.

2. The image processing module according to claim 1,
wherein the noise comprises at least one among low intensity, blur, haze (diffraction ghost), reflection ghost, color separation, flare, fringe pattern, and yellowish phenomenon.

3. The image processing module according to claim 1,
wherein the input unit receives the first image data from an image sensor disposed under the display panel.

4. The image processing module according to claim 1,
wherein the first image data and the second image data have different noise levels.

5. The image processing module according to claim 1,
Wherein the training set of the deep learning neural network comprises a first image data generated using light transmitted through a display panel and a second image data generated using light not transmitted through a display panel.

6. The image processing module according to claim 1,
wherein at least one of the first image data and the second image data is Bayer image data.

7. The image processing module according to claim 1,
wherein the second image data is outputted to an image signal processor.

8. An image processing method comprising the steps of:
generating a first image data using light transmitted through a display panel; and
outputting a second image data from the first image data using a learned deep learning neural network,
wherein the second image data is image data in which at least a portion of noise, which is a picture quality degradation phenomenon that occurs when the light transmits through a display panel, is removed.

9. The image processing method according to claim 8,
wherein a training set of the deep learning neural network comprises a first image data generated using light transmitted through a display panel and a second image data generated using light not transmitted through a display panel.

10. The image processing method according to claim 8,
wherein the first image data is received from an image sensor disposed under the display panel, and
wherein the second image data is outputted to an image signal processor.

11. An image sensor comprising:
an image sensing unit configured to generate a first image data using light transmitted through a display panel; and
a deep learning neural network configured to output a second image data from the first image data;
wherein the second image data is image data from which at least a portion of noise, which is a picture quality degradation phenomenon that occurs when the light transmits through the display panel, is removed.

12. The image sensor according to claim 11, comprising:
an output unit configured to output the second image data to outside,
wherein the deep learning neural network outputs the second image data according to an output format of the output unit.

13. The image sensor according to claim 11, comprising:
an alignment unit configured to output a third image data by decomposing or rearranging at least a portion of the first image data,
wherein the deep learning neural network outputs the second image data from the third image data.

14. The image sensor according to claim 13,
wherein the alignment unit outputs the third image data according to an output format of the output unit.

15. The image sensor according to claim 11,
wherein the first image data and the second image data have different noise levels.

16. The image sensor according to claim 11,
wherein the training set of the deep learning neural network comprises a first image data generated using light transmitted through a display panel and a second image data generated using light not transmitted through a display panel.

17. The image sensor according to claim 11,
wherein at least one of the first image data and the second image data is a Bayer image data.

18. The image sensor according to claim 11,
wherein the second image data is outputted to an image signal processor outside from the image sensor.

19. The image processing method according to claim 8,
wherein the noise comprises at least one among low intensity, blur, haze (diffraction ghost), reflection ghost, color separation, flare, fringe pattern, and yellowish phenomenon.

20. The image processing method according to claim 8,
wherein the first image data and the second image data have different noise levels.
